(19) United States
(12) Patent Application Publication
(10) Pub. No.: US 2026/0004007 A1
(43) Pub. Date: Jan. 1, 2026

(54) INFORMATION PROCESSING APPARATUS, INFORMATION PROCESSING SYSTEM, AND INFORMATION PROCESSING METHOD

(71) Applicant: TOYOTA JIDOSHA KABUSHIKI KAISHA, Toyota-shi (JP)

(72) Inventors: Keisuke ISOMURA, Kariya-shi (JP); Tatsuhiko SASAKI, Toyota-shi (JP); Iwao NITTA, Nagoya-shi (JP); Aya OHKUBO, Nisshin-shi (JP); Sotaro HAYASHI, Okazaki-shi (JP); Masahiro KAGAMI, Nagoya-shi (JP); Hiroshi YAMASAKI, Nagoya-shi (JP); Makoto MIZUGUCHI, Toyota-shi (JP); Kenta KIMURA, Nagoya-shi (JP); Yasuhiro KOBATAKE, Nagoya-shi (JP)

(73) Assignee: TOYOTA JIDOSHA KABUSHIKI KAISHA, Toyota-shi (JP)

(21) Appl. No.: 19/247,796

(22) Filed: Jun. 24, 2025

(30) Foreign Application Priority Data
Jun. 26, 2024 (JP) 2024-103423

(51) Int. Cl. G06F 21/81

(52) U.S. Cl. CPC G06F 21/81; G06F 2221/2111

(57) ABSTRACT

An information processing apparatus comprises a controller, the controller being configured to execute: determining, for a battery apparatus mountable on a vehicle, whether predetermined information for tracking a location of the battery apparatus is registered with a predetermined management apparatus or not; and disabling at least part of functions provided by the battery apparatus mounted on the vehicle when it is determined that the predetermined information is not registered.

### CROSS REFERENCE TO THE RELATED APPLICATION

This application claims the benefit of Japanese Patent Application No. 2024-103423, filed on Jun. 26, 2024, which is hereby incorporated by reference herein in its entirety.

### BACKGROUND

### Technical Field

The present disclosure relates to a vehicle technology.

### Description of the Related Art

There is known a technology for providing information about the battery of an electric vehicle.

In relation to thereto, for example, Japanese Patent Laid-Open No. 2021-191159 discloses a system that determines the degree of deterioration of a battery mounted on a vehicle and notifies the user of the necessity to change the battery.

### SUMMARY

An object of the present disclosure is to urge registration of information for tracking a battery mounted on a vehicle.

The present disclosure in its one aspect provides an information processing apparatus comprising a controller, the controller being configured to execute: determining, for a battery apparatus mountable on a vehicle, whether predetermined information for tracking a location of the battery apparatus is registered with a predetermined management apparatus or not; and disabling at least part of functions provided by the battery apparatus mounted on the vehicle when it is determined that the predetermined information is not registered.

The present disclosure in its another aspect provides An information processing system comprising: a first apparatus configured to manage predetermined information for tracking a location of a battery apparatus mountable on a vehicle; and a second apparatus communicable with a battery control device that the battery apparatus comprises, wherein when the battery apparatus is removed from a first vehicle, the first apparatus accepts registration of the predetermined information about the battery apparatus, and the second apparatus executes: determining whether the predetermined information corresponding to the battery apparatus is registered with the first apparatus or not; and disabling at least part of functions provided by the battery apparatus mounted on a second vehicle when it is determined that the predetermined information is not registered.

The present disclosure in its another aspect provides an information processing method for an information processing apparatus to execute: determining, for a battery apparatus mountable on a vehicle, whether predetermined information for tracking a location of the battery apparatus is registered with a predetermined management apparatus or not; and disabling at least part of functions provided by the battery apparatus mounted on the vehicle when it is determined that the predetermined information is not registered.

As another aspect, a program for causing a computer to execute the above method or a computer-readable storage medium that non-transitorily stores the program is given.

According to the present disclosure, it is possible to urge registration of information for tracking a battery mounted on a vehicle.

### BRIEF DESCRIPTION OF THE DRAWINGS

FIG. 1 is a schematic diagram of a battery management system according to a first embodiment;

FIG. 2 is a hardware configuration diagram of a server apparatus according to the first embodiment;

FIG. 3 is a hardware configuration diagram of a business operator terminal according to the first embodiment;

FIG. 4 is a hardware configuration diagram of a vehicle according to the first embodiment;

FIG. 5 is a hardware configuration diagram of a battery pack according to the first embodiment;

FIG. 6 is a software configuration diagram of the server apparatus according to the first embodiment;

FIG. 7 illustrates an example of tracking information stored in the server apparatus;

FIG. 8 is a software configuration diagram of the business operator terminal according to the first embodiment;

FIG. 9 is a software configuration diagram of the vehicle according to the first embodiment;

FIG. 10 is a software configuration diagram of the battery pack according to the first embodiment;

FIG. 11 illustrates an example of a list of functions stored in the battery pack;

FIG. 12 is a sequence diagram of a process for registering the tracking information with the server apparatus;

FIG. 13 is a first sequence diagram of a process executed when the battery pack is mounted;

FIG. 14 is a second sequence diagram of the process executed when the battery pack is mounted;

FIG. 15 is a third sequence diagram of the process executed when the battery pack is mounted; and

FIG. 16 is a fourth sequence diagram of the process executed when the battery pack is mounted.

### DESCRIPTION OF THE EMBODIMENTS

Recently, vehicles mounted with a drive battery and capable of traveling with electricity as an energy source, such as battery electric vehicles (BEV) and plug-in hybrid electric vehicles (PHEV), have been increasing in number.

It is anticipated that, when electric vehicles are more widespread, a business for sales/purchase of a battery removed from a used vehicle will be active. There is, however, a possibility that the battery of a used vehicle will be harmful to environment if it is not correctly recycled. Furthermore, even in a case where a battery is recycled and mounted on a new vehicle, it is not possible to correctly estimate the value thereof unless it is evaluated in a correct method specified by a vehicle manufacturer.

In order to solve these problems, it is preferable to enable a manufacturer (a vehicle manufacturer or the like) to track a battery removed from a vehicle. In the current situation, however, when a battery is separated from a vehicle once, it is difficult for a vehicle manufacturer or the like to grasp the location of the battery.

An information processing apparatus according to the present disclosure solves such a problem.

An information processing apparatus according to one aspect of the present disclosure includes a controller, the controller being configured to execute: determining, for a battery apparatus mountable on a vehicle, whether predetermined information for tracking a location of the battery apparatus is registered with a predetermined management apparatus or not; and disabling at least part of functions provided by the battery apparatus mounted on the vehicle when it is determined that the predetermined information is not registered.

The information processing apparatus is, for example, a computer mounted on a vehicle (a vehicle ECU) or a computer mounted on a battery apparatus (a battery ECU).

The controller of the information processing apparatus determines, for a target battery apparatus, whether or not predetermined information is registered with a predetermined management apparatus. The predetermined information is information for tracking the location of the battery apparatus, and, for example, information about a business operator who removed the battery apparatus from a vehicle, the purpose of the removal, a transferee after the removal, and the like.

The predetermined information is typically registered with the predetermined management apparatus (for example, a center server) at the timing when the battery apparatus is removed from the vehicle. The predetermined management apparatus may be the information processing apparatus itself.

Furthermore, when the predetermined information is not registered with the management apparatus, the controller disables at least part of functions provided by the battery apparatus newly mounted on a vehicle.

For example, if the predetermined information is not registered with the management apparatus when a battery apparatus is removed from a vehicle, it becomes impossible to use at least part of functions of the battery apparatus on a vehicle on which the battery apparatus is re-mounted.

As for the functions provided by the battery apparatus, there may be a plurality of functions, for example, functions required for a vehicle to travel, and a function of providing history information and the like. The controller may selectively disable the functions.

When functions are disabled as described above, the value of the battery apparatus on the market may decrease. According to such a configuration, it is possible to give a business operator or the like a motivation for registering information at the time of removing a battery apparatus, and obtain the effect that it becomes easy to track the battery.

The information processing apparatus may be an apparatus capable of communicating with a control device (an ECU or the like) included in a battery apparatus (for example, an ECU mounted on a vehicle). In this case, when there is no registration about the target battery apparatus, the controller may instruct the control device included in the target battery apparatus to disable functions. Furthermore, it is also possible to disable the functions by restricting communication performed between the control device and the apparatus itself.

Furthermore, the controller may disable second functions, among the plurality of functions provided by the battery apparatus, without disabling first functions. It is preferable that the first functions are functions required for a vehicle to travel and functions for ensuring safety. In this case, the second functions may include a function of providing accompanying information.

According to such a configuration, it becomes possible, for example, to disable provision of accompanying information while maintaining the safety performance of a vehicle mounted with a reused battery. Thereby, it is possible to give a business operator or the like a motivation for registering information at the time of removing a battery apparatus.

Furthermore, the controller may make a determination about whether the predetermined information is registered or not when detecting that the battery apparatus has been mounted on a vehicle.

For example, when the information processing apparatus is mounted on the vehicle side, it may be determined that a battery apparatus has been mounted on the vehicle when communication is newly established with the control device of the battery apparatus.

Furthermore, when the predetermined information corresponding to the battery apparatus is registered with the predetermined management apparatus, the controller may store a combination of the vehicle mounted with the battery apparatus and the battery apparatus. Furthermore, the controller may be adapted not to, when the combination of the vehicle mounted with the battery apparatus and the battery apparatus is already stored in the storage, determine whether the predetermined information is registered or not.

Specific embodiments of the present disclosure will be described below based on the drawings. The hardware configuration, the module configuration, the functional configuration, and the like described in each embodiment are not intended to limit the technological scope of the present disclosure only thereto unless otherwise stated.

### First Embodiment

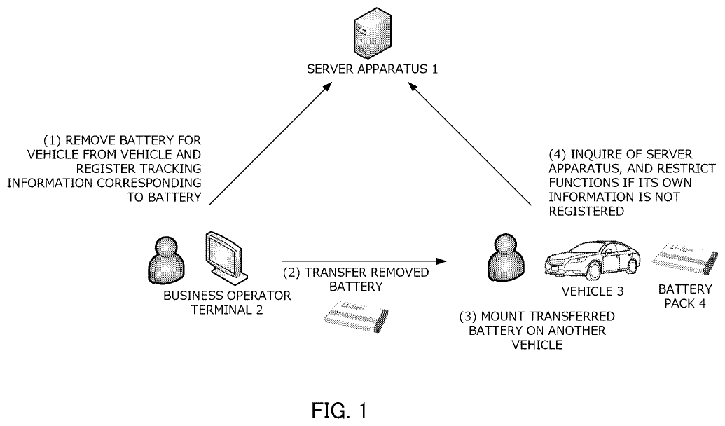

An overview of a battery management system according to a first embodiment will be described with reference to FIG. 1. The battery management system according to the present embodiment is a system that manages information about a battery pack 4 designed for a vehicle 3, which is an electric vehicle, by a server apparatus 1. The battery pack 4 is a unit obtained by adding a computer for control to a drive battery for a vehicle. In the description of the embodiments, a battery pack will also be referred to simply as a battery. A battery pack can be removed from an original vehicle and, for example, can be mounted on another electric vehicle or reused as a home storage battery or the like.

The server apparatus 1 is a computer that collects and manages information about battery packs mounted on vehicles. The server apparatus 1 may be an apparatus operated by a vehicle manufacturer that has manufactured the vehicle 3.

When the server apparatus 1 is operated by a vehicle manufacturer, the server apparatus 1 may manage information about battery packs mounted on vehicles manufactured by the vehicle manufacturer. For example, the server apparatus 1 may collect information about vehicles such as the identifier, position information, speed, and mileage of the vehicle 3 at predetermined intervals and stores the information in association with information about the battery pack 4. Thereby, the server apparatus 1 can grasp the latest statuses of the vehicle 3 and the battery pack 4.

In general, the battery pack 4 is used in a state of being associated with the vehicle 3. When the battery pack 4 is removed from the vehicle 3, however, it becomes difficult to track the battery pack that is not equipped with a communication device.

Therefore, in the present embodiment, the server apparatus 1 acquires information for tracking the target battery pack 4 (“predetermined information” in the present disclosure; hereinafter referred to as tracking information) from a terminal of a business operator who has removed the battery pack (a business operator terminal 2) at a timing of the battery pack 4 being removed from the vehicle 3, and manages the information.

Furthermore, in the present embodiment, when the removed battery pack is transferred and mounted on another vehicle, a process for authenticating the battery pack is executed. Specifically, the battery pack newly connected to the vehicle inquires of the server apparatus 1 about whether there is tracking information about itself and, if the tracking information is not registered with the server apparatus 1, predetermined functions, among a plurality of functions provided by the battery pack, are disabled. If the tracking information is registered with the server apparatus 1, the restriction of the functions is not imposed, and use of all the functions of the battery pack is enabled.

In the present specification, the process is referred to as “re-mounting authentication”.

According to such a configuration, a motivation for registering tracking information with the server apparatus 1 occurs at the time of removing a battery pack from a vehicle. Thereby, it becomes possible to urge registration of tracking information, and it becomes easy to track a battery pack removed from a vehicle.

### [Hardware Configuration]

Next, the hardware configuration of each apparatus constituting the system will be described.

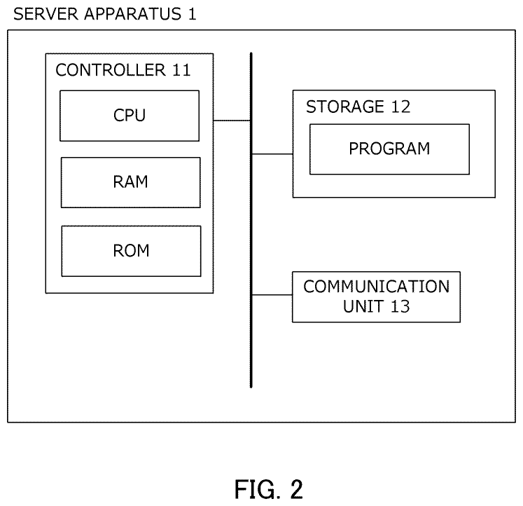

First, components of the server apparatus 1 will be described. FIG. 2 is a diagram schematically illustrating an example of the hardware configuration of the server apparatus 1.

The server apparatus 1 can be configured as a computer that includes a processor (a CPU, a GPU, or the like), a main memory (a RAM, a ROM, and the like), and an auxiliary storage device (an EPROM, a hard disk drive, a removable medium, or the like). In the auxiliary storage device, an operating system (OS), various kinds of programs, various kinds of tables, and the like are stored. By executing a program stored in the auxiliary storage device, each of functions (software modules) that meet predetermined purposes as described later can be realized. Part or all of the functions, however, may be realized as hardware modules by a hardware circuit, for example, an ASIC or an FPGA.

The server apparatus 1 includes a controller 11, a storage 12, and a communication unit 13.

The controller 11 is an arithmetic unit that realizes the various functions of the server apparatus 1 by executing a predetermined program. The controller 11 can be realized, for example, by a hardware processor such as a CPU. Furthermore, the controller 11 may include a RAM, a read-only memory (ROM), and a cache memory.

The storage 12 is means for storing information and includes a main memory and an auxiliary storage device. The main memory is a memory where the program executed by the controller 11 and data used by the control program are developed. The auxiliary storage device is a device in which the program executed by the controller 11 and the data used by the control program are stored. In the auxiliary storage device, what is obtained by packaging the program executed by the controller 11 as an application may be stored. An operating system for executing such an application may be stored. By the program stored in the auxiliary storage device being loaded to the main memory and executed by the controller 11, processes described later are performed.

As the main memory, a random-access memory (RAM) and a read-only memory (ROM) may be included. As the auxiliary storage device, an erasable programmable ROM (EPROM) or a hard disk drive (HDD) may be included. Furthermore, as the auxiliary storage device, a removable medium, that is, a removable recording medium may be included.

The communication unit 13 is a communication interface for connecting the server apparatus 1 to a network. The communication unit 13 may be a wired communication interface or may be a wireless communication interface.

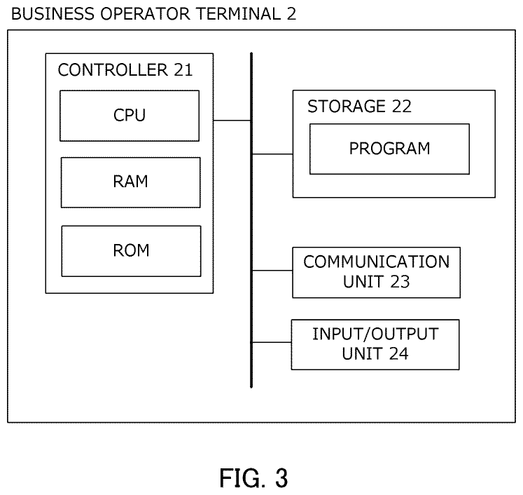

Next, components of the business operator terminal 2 will be described. FIG. 3 is a diagram schematically illustrating an example of the hardware configuration of the business operator terminal 2.

The business operator terminal 2 can be configured as a computer that includes a processor (a CPU, a GPU, or the like), a main memory (a RAM, a ROM, and the like), and an auxiliary storage device (an EPROM, a hard disk drive, a removable medium, or the like) similarly to the server apparatus 1.

The business operator terminal 2 includes a controller 21, a storage 22, a communication unit 23, and an input/output unit 24.

The controller 21 is an arithmetic unit that realizes various functions of the business operator terminal 2 by executing a predetermined program. The controller 21 can be realized, for example, by a hardware processor such as a CPU. Furthermore, the controller 21 may include a RAM, a read-only memory (ROM), and a cache memory.

The storage 22 is means for storing information and is configured with a storage medium such as a RAM, a magnetic disk, or a flash memory. In the storage 22, the program executed by the controller 21 and the data and the like used by the program are stored.

The communication unit 23 is a communication interface for connecting the business operator terminal 2 to a network. The communication unit 23 may be a wired communication interface or may be a wireless communication interface.

The input/output unit 24 is a unit that accepts an input from an operator of the business operator terminal 2 and presents information to the operator. Specifically, the input/output unit 24 is configured with a touch panel and control means therefor, and a liquid crystal display and control means therefor. In the present embodiment, the touch panel and the liquid crystal display are configured with one touch panel display. The input/output unit 24 may include hardware interfaces such as a keyboard and a mouse.

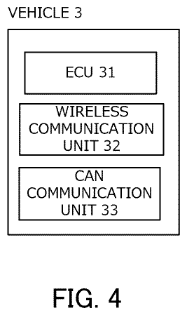

Next, the vehicle 3 will be described. FIG. 4 is a diagram schematically illustrating an example of the hardware configuration of the vehicle 3.

The vehicle 3 is a battery electric vehicle mounted with the battery pack 4. The vehicle 3 is typically a battery EV (BEV) but may be, for example, a plug-in hybrid electric vehicle if the vehicle is driven by a drive battery.

The vehicle 3 is wirelessly connected to the server apparatus 1. Furthermore, the vehicle 3 is communicably connected to the battery pack 4 via an in-vehicle network (a CAN network).

The vehicle 3 includes an ECU 31, a wireless communication unit 32, and a CAN communication unit 33.

The ECU 31 is an electronic control unit responsible for travel of the vehicle 3. In addition to controlling components required for travel of the vehicle, such as an engine and a motor, the ECU 31 performs communication with the battery pack 4 described later to relay data required for re-mounting authentication of the battery pack 4.

The wireless communication unit 32 is a wireless communication interface for connecting the vehicle 3 to a network. The wireless communication unit 32 is configured to be communicable with the server apparatus 1, for example, via a wireless LAN or a mobile communication service such as 3G, 4G or 5G.

The CAN communication unit 33 is a communication interface for communication with the in-vehicle network provided in the vehicle 3. The CAN communication unit 33 performs communication via a CAN (controller area network) network.

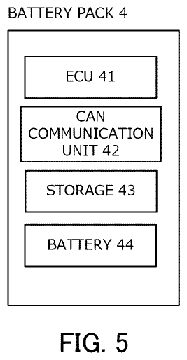

Next, the battery pack 4 will be described. FIG. 5 is a diagram schematically illustrating an example of the hardware configuration of the battery pack 4.

The battery pack 4 is a unit obtained by adding, to a battery body (a battery 44) such as a lithium-ion battery, a computer for performing charge/discharge control of the battery (an ECU 41), a CAN communication unit 42, and a storage 43.

The ECU 41 performs charge/discharge control of the battery body in cooperation with the ECU 31 of the vehicle 3. Further, the ECU 41 executes re-mounting authentication of the battery pack 4 when the battery pack 4 is connected to a new vehicle.

In the present embodiment, when the vehicle 3 and the battery pack 4 are newly connected, the ECU 41 detects it and inquires of the server apparatus 1 about whether there is tracking information or not via the vehicle 3. If existence of the tracking information can be confirmed, the ECU 41 enables all the functions of the battery pack 4. If existence of the tracking information cannot be confirmed, the ECU 41 disables predetermined functions among the functions provided by the battery pack 4 (that is, disables the functions from being provided).

The CAN communication unit 42 is an interface for connecting the battery pack 4 to the in-vehicle network of the vehicle 3. The ECU 41 can communicate with the vehicle 3 (the CAN communication unit 33) via the CAN communication unit 42.

The storage 43 is means for storing information and is configured with a storage medium such as a RAM, a magnetic disk, or a flash memory. In the storage 43, a program executed by the ECU 41 and the data and the like used by the program are stored.

### [Software Configuration]

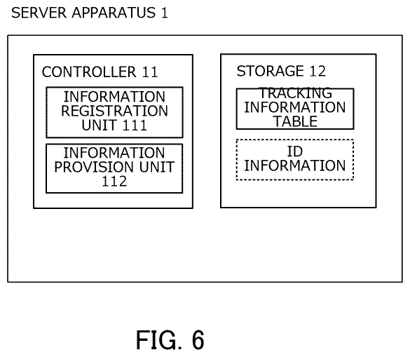

Next, the software configuration of each apparatus constituting the system will be described. FIG. 6 is a diagram schematically illustrating the software configuration of the server apparatus 1 according to the present embodiment.

In the present embodiment, the controller 11 of the server apparatus 1 includes two software modules of an information registration unit 111 and an information provision unit 112. Each software module may be realized by executing the program stored in the storage 12 described later by the controller 11 (a CPU or the like). Information processing executed by the software modules is synonymous with information processing executed by the controller 11 (a CPU or the like).

The information registration unit 111 acquires information (tracking information) about a predetermined battery pack from the business operator terminal 2 in response to a request from the business operator terminal 2. As described above, the business operator who has removed the battery pack 4 from the vehicle 3 transmits the information for tracking the battery pack 4 to the server apparatus 1 using the business operator terminal 2. The information registration unit 111 receives the information and stores the information into the storage 12 (a tracking information table) as illustrated in FIG. 6.

There may be a case where, in the tracking information table stored in the server apparatus 1, a record about the target battery pack already exists. In this case, the information registration unit 111 may generate a new record of the tracking information table based on the received information.

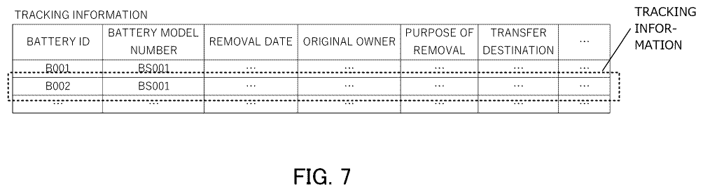

FIG. 7 illustrates an example of the tracking information table. As illustrated in FIG. 7, the tracking information table includes information about IDs for vehicle manufacturers to uniquely identify batteries (battery IDs), model numbers of the batteries, dates when the batteries were removed, owners of the batteries at the time of the removal, and the like. Furthermore, the tracking information table may include purposes of the removal of the batteries, transfer destinations of the batteries, and the like. By referring to the tracking information table, it is possible to identify, for example, a transfer destination of a battery and, thereby, obtain information for estimating where the target battery currently exists.

In response to an inquiry transmitted from the vehicle 3 or the battery pack 4, the information provision unit 112 determines whether or not a record corresponding to the specified battery pack exists in the tracking information table stored in the storage 12. For example, when receiving an inquiry from a battery pack with a battery ID of “B001” in the example of FIG. 7, the information provision unit 112 returns a reply to the effect that “a tracking information record exists for the specified battery pack”.

The storage 12 stores the tracking information table described above. The “ID information” in FIG. 6 will be described later.

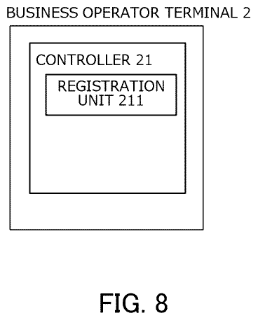

Next, the software configuration of the business operator terminal 2 will be described. FIG. 8 is a diagram schematically illustrating the software configuration of the business operator terminal 2 according to the present embodiment.

The controller 21 of the business operator terminal 2 includes a registration unit 211 as a functional module. The functional module may be realized by executing a stored program by the CPU.

The registration unit 211 acquires tracking information about a target battery pack 4 and transmits the acquired tracking information to the server apparatus 1 via the input/output unit 24. The registration unit 211 accepts an input of information, for example, about an ID for identifying the target battery pack (a battery ID), the model number of the battery, a date when the battery was removed, the owner of the battery at the time of the removal from the operator, and transmits the information to the server apparatus 1. When the reuse destination or transfer destination of the removed battery pack is known, information thereabout may be included in the tracking information.

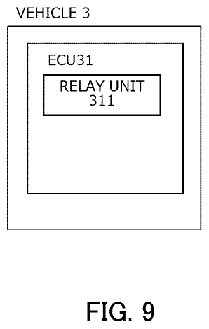

Next, the software configuration of the vehicle 3 will be described. FIG. 9 is a diagram schematically illustrating the software configuration of the vehicle 3 according to the present embodiment.

The ECU 31 of the vehicle 3 includes a relay unit 311 as a functional module. The functional module may be realized by executing a stored program by the CPU.

The relay unit 311 has a role of relaying data transmitted from the battery pack 4 connected to the vehicle 3, to the server apparatus 1. For example, the relay unit 311 transfers an inquiry transmitted from the battery pack 4 to the server apparatus 1, and transfers a reply transmitted from the server apparatus 1 to the battery pack 4. Thereby, it becomes possible for the battery pack 4 without a communication function to interact with the server apparatus 1.

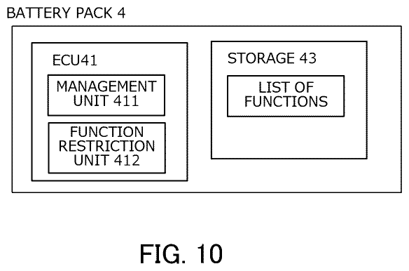

Next, the software configuration of the battery pack 4 will be described. FIG. 10 is a diagram schematically illustrating the software configuration of the battery pack 4 according to the present embodiment.

The ECU 41 of the battery pack 4 includes two functional modules of a management unit 411 and a function restriction unit 412. These functional modules may be realized by executing a stored program by the CPU.

The management unit 411 performs charge/discharge control of the battery body in cooperation with the ECU 31 of the vehicle 3. The management unit 411 provides the plurality of functions exemplified in the present specification. The management unit 411 is an example of a “battery control device” in the present disclosure.

When the battery pack 4 is newly connected to a vehicle, the function restriction unit 412 executes re-mounting authentication of the battery pack 4. Specifically, the function restriction unit 412 detects that the battery pack 4 has been connected to a new vehicle 3, and transmits data inquiring whether tracking information corresponding to the battery pack 4 is registered or not to the server apparatus 1 via the vehicle 3. It can be determined that the battery pack 4 has been newly connected to the vehicle 3, for example, based on the identifier or the like of the ECU 31 of the vehicle 3. Therefore, the function restriction unit 412 may store information about a history of vehicles 3 to which the battery pack 4 was connected in the past (a list of ECU identifiers, or the like).

The function restriction unit 412 receives a reply transmitted from the server apparatus 1 in response to the inquiry. For example, if the content of the reply is that “the tracking information about the inquired battery pack does not exist”, the function restriction unit 412 performs a process for restricting (disabling) predetermined functions among the plurality of functions of the battery pack 4. For example, the function restriction unit 412 issues an instruction to disable the predetermined functions, to the management unit 411.

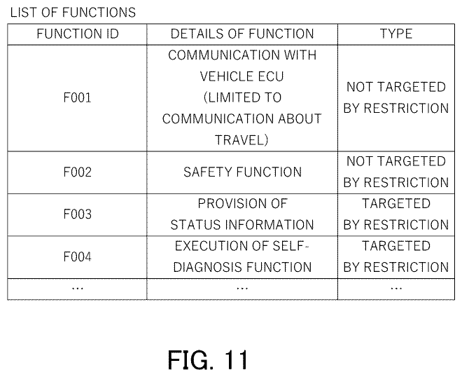

The function restriction unit 412 determines the functions to be disabled based on a list of functions stored in the storage 43. FIG. 11 illustrates an example of the list of functions. Here, it is assumed that the battery pack 4 has four functions as illustrated in FIG. 11.

The first (the function ID: F001) is a function of performing communication required for travel of a vehicle with an ECU on the vehicle side.

The second (the function ID: F002) is a function of ensuring safety for travel, for example, an overcurrent protection function and a temperature monitoring function.

The third (the function ID: F003) is a function of providing status information that the battery pack 4 has. The status information may be, for example, information about battery deterioration such as the number of charge/discharge cycles and state of health (SoH).

The fourth (the function ID: F004) is a self-diagnosis function. By executing self-diagnosis, the status information is updated to the latest.

In the illustrated example, only two functions, F003 and F004, are to be disabled. When these functions are disabled, it is disabled to perform self-diagnosis to generate status information and to read out the status information.

Note that the configurations illustrated in FIGS. 2 to 6 and FIGS. 8 to 10 are examples, and all or part of the illustrated functions may be executed with dedicatedly designed circuits. Furthermore, storage or execution of a program may be performed by a combination of a main memory and an auxiliary storage device other than the illustrated combination.

Next, a process executed by each apparatus included in the system will be described.

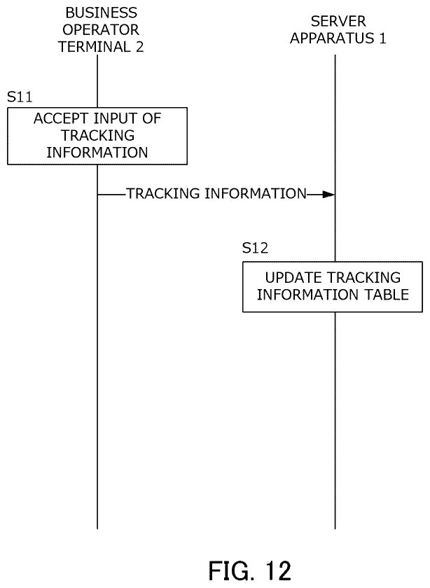

FIG. 12 is a sequence diagram of a process for the server apparatus 1 to acquire information about the battery pack 4 removed from the vehicle 3, from the business operator terminal 2. The illustrated process is executed at the timing when the battery pack 4 has been removed from the vehicle 3. The process may be started by an operation of the business operator terminal 2 owned by a business operator who has removed the battery pack 4.

First, at step S11, the business operator terminal 2 accepts an input of tracking information about the target battery pack. As illustrated in FIG. 7, the tracking information may include an identifier for uniquely identifying the battery, the business operator who performs removal, the original owner, the purpose of the removal, and the like. Furthermore, when the removal has been already performed, a removal date, a transfer destination, and the like may be included in the tracking information.

The inputted tracking information is transmitted to the server apparatus 1.

At step S12, the server apparatus 1 (the information registration unit 111) stores the received tracking information into the storage 12 (the tracking information table). For example, the information registration unit 111 generates a record corresponding to the received tracking information and adds the record to the tracking information table.

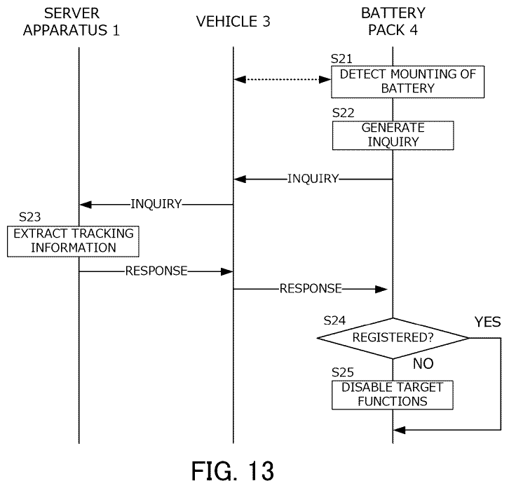

Next, a description will be made on a process executed when the removed battery pack 4 is mounted on another vehicle. FIG. 13 is a sequence diagram illustrating an example of the process executed when the battery pack 4 is re-mounted on another vehicle.

When the battery pack 4 is newly mounted on the vehicle 3, the ECU 41 of the battery pack 4 and the ECU 31 of the vehicle 3 become communicable with each other. Thereby, the ECU 41 recognizes that the battery pack 4 has been mounted on the vehicle 3 (step S21).

The ECU 41 may be configured to be capable of storing the identifiers of vehicle-side ECUs with which communication was established in the past. Thereby, it becomes possible for the ECU 41 to determine whether the battery pack 4 has been mounted on the target vehicle 3 for the first time or not. The ECU 41 may execute the process described below only when the ECU 41 has not communicated with the ECU 31 to be a communication counterpart in the past.

When recognizing that the battery pack 4 has been mounted on the vehicle 3, the ECU 41 generates data for inquiring of the server apparatus 1 about whether tracking information about the battery pack 4 is registered or not (step S22). The inquiry includes the identifier (the battery ID) of the battery pack. The inquiry is transmitted to the server apparatus 1 via the vehicle 3 (the ECU 31).

The server apparatus 1 (the information provision unit 112) that has received the inquiry searches the tracking information table with the battery ID included in the inquiry as a key and extracts a corresponding record (step S23). As a result, if one or more records corresponding to the battery ID are extracted, the server apparatus 1 generates a response to the effect that the battery related to the inquiry is registered (acknowledgement) and transmits the response to the vehicle 3 (the ECU 31). If no records corresponding to the battery ID exist, the server apparatus 1 generates a response to the effect that no battery related to the inquiry is registered (negative acknowledgement) and transmits the response to the vehicle 3 (the ECU 31). The ECU 31 transfers the received response to the battery pack 4 (the ECU 41).

At step S24, the battery pack 4 (the ECU 41) determines the content of the response. If the response is acknowledgement, the process ends. If the response is negative acknowledgement, the process transitions to step S25, where the ECU 41 disables target functions based on the list of functions stored in the storage 43.

For example, in the case of the example of FIG. 11, provision of the “status information provision function” and the “self-diagnosis function” is restricted by disabling the target functions.

Note that the ECU 41 may execute disabling of the target functions in the case of failing in transmission of the inquiry or in the case of not obtaining the response from the server apparatus 1. That is, if acknowledgement is not obtained from the server apparatus 1 within a predetermined period, the ECU 41 may disable the target functions.

As described above, in the battery management system according to the present embodiment, when a management target battery pack is removed from a vehicle and re-mounted on another vehicle, a process for authenticating the battery pack (re-mounting authentication) is executed. When information for tracking the battery pack (tracking information) is not registered with the server apparatus 1 in the re-mounting authentication, function restrictions are imposed on the battery pack. Since a battery pack for which tracking information is not registered cannot provide complete functions in comparison with a battery pack for which tracking information is registered, the value on the market decreases. Thereby, it is possible to create a motivation for registering tracking information at the time of removing a battery pack, and it becomes easy to track a battery by a vehicle manufacturer or the like.

It is also possible to, even if restrictions are imposed on reading of status information, enable the restrictions to be released by registering tracking information later. Thereby, the purpose of enabling tracking of a battery pack can be achieved.

### Second Embodiment

In the first embodiment, the ECU 41 of the battery pack 4 determines whether or not to disable target functions. Meanwhile, whether or not to disable the target functions may be determined by the ECU 31 on the vehicle side.

A second embodiment is an embodiment in which the ECU 31 of the vehicle 3 detects re-mounting of the battery pack 4 and determines whether or not to disable functions.

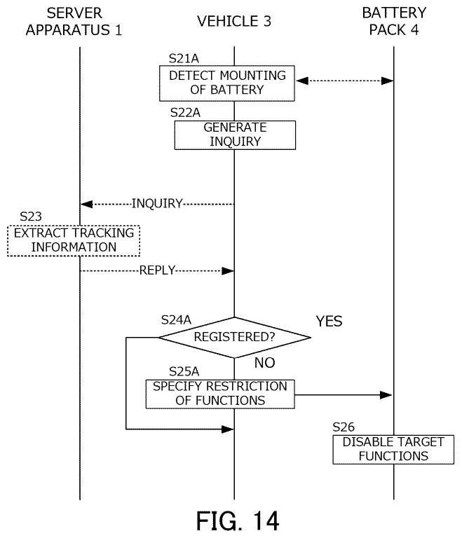

FIG. 14 is a sequence diagram illustrating an example of the process executed when the battery pack 4 is re-mounted on a vehicle.

When the battery pack 4 is mounted on the vehicle 3, the ECU 41 of the battery pack 4 and the ECU 31 of the vehicle 3 become communicable with each other. Thereby, the ECU 31 of the vehicle 3 recognizes that the battery pack 4 has been mounted on the vehicle 3 (step S21A).

The ECU 31 may be configured to be capable of storing the identifiers of ECUs of battery packs 4 with which communication was established in the past. Thereby, the ECU 31 can determine whether the battery pack 4 has been mounted on the vehicle 3 for the first time or not. The ECU 31 may execute the process described below only when the ECU 31 has not communicated with the ECU 41 to be a communication counterpart in the past.

When recognizing that the battery pack 4 has been mounted on the vehicle 3, the ECU 31 generates an inquiry for confirming whether tracking information about the battery pack 4 is registered or not to the server apparatus 1 (step S22A). The inquiry includes the identifier (the battery ID) of the battery pack. The inquiry is transmitted to the server apparatus 1.

The server apparatus 1 (the information provision unit 112) that has received the inquiry generates acknowledgement or negative acknowledgement by a process similar to step S23 of the first embodiment and transmits it to the vehicle 3 (the ECU 31).

At step S24A, the vehicle 3 (the ECU 31) determines the content of the response. If the response is acknowledgement, the process ends. If the response is negative acknowledgement, the process transitions to step S25A, where the ECU 31 transmits data specifying restriction of functions to the battery pack 4 (the ECU 41). The ECU 41 that has received the data disables target functions based on the list of functions stored in the storage 43.

### Third Embodiment

In the first embodiment, the ECU 41 of the battery pack 4 disables target functions. Meanwhile, disabling of functions may be realized by a vehicle-side ECU.

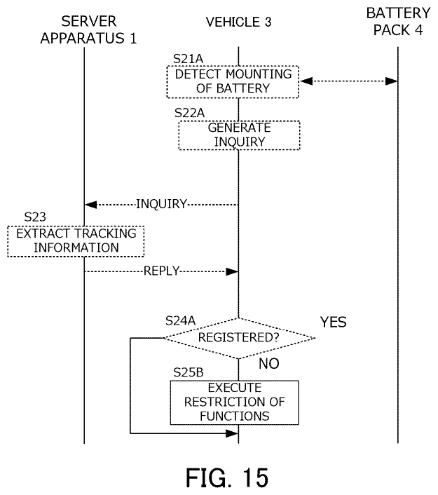

FIG. 15 is a sequence diagram illustrating an example of the process executed when the battery pack 4 is re-mounted on a vehicle.

In the sequence of the process in the present embodiment, only the process in the case where tracking information corresponding to the target battery pack 4 is not registered with the server apparatus 1 (step S25B) is different in comparison with the sequence of the process in the second embodiment (FIG. 14).

At step S25B, the ECU 31 of the vehicle 3 executes a process for restricting access to the restriction target functions among the functions provided by the battery pack 4. At this step, the ECU 31 may inquire of the ECU 41 about which are the restriction target functions in advance.

For example, in the case of the example of FIG. 11, when access to the target functions is restricted, it is disabled to execute “provision of status information” and “self-diagnosis” even if the driver of the vehicle requests execution. Thus, it is also possible to disable target functions by providing access restrictions between apparatuses.

### Fourth Embodiment

In the first embodiment, the ECU 41 of the battery pack 4 determines whether or not to disable functions. In the second and third embodiments, the ECU 31 of the vehicle 3 determines whether or not to disable functions. Meanwhile, whether or not to disable functions provided by the battery pack 4 may be determined by the server apparatus 1.

The present embodiment is an embodiment in which the server apparatus 1 determines whether or not to disable functions provided by the battery pack 4, and the server apparatus 1 causes target functions to be disabled, by instructing the ECU 41 of the battery pack 4 to do so.

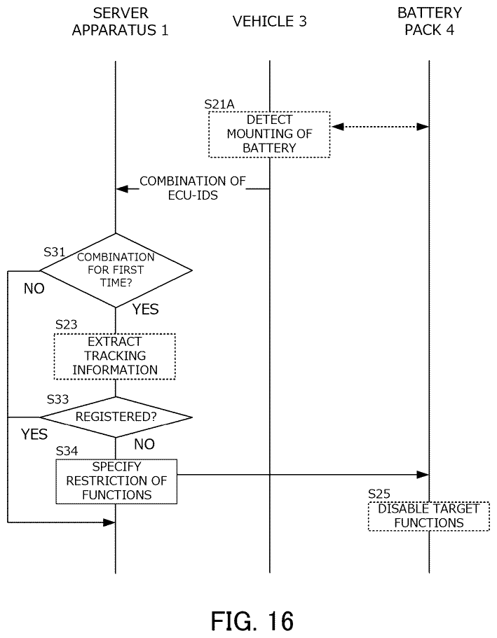

FIG. 16 is a sequence diagram illustrating an example of the process executed when the battery pack 4 is re-mounted on a vehicle.

In the present embodiment, the ECU 31 of the vehicle 3 detects that the battery pack 4 has been newly mounted (step S21A) as in the second embodiment. The present embodiment, however, is different from the second embodiment in that the server apparatus 1 determines whether or not to restrict functions.

In the present embodiment, when determining that the battery pack 4 has been newly mounted, the ECU 31 transmits a combination of the identifier (ECU-ID) of the ECU 31 and the identifier (ECU-ID) of the ECU (the ECU 41) of the battery pack 4 to the server apparatus 1.

In the present embodiment, the server apparatus 1 is configured to be capable of storing combinations of ECU-IDs detected in the past. The “ID information” illustrated in FIG. 6 is a list showing combinations of ECU-IDs that the server apparatus 1 detected in the past. By referring to the list, the server apparatus 1 can determine whether the target battery pack 4 has been mounted on the target vehicle 3 for the first time or not.

The server apparatus 1 determines whether the combination of the ECU-IDs described above has been acquired for the first time or not based on the ID information described above (step S31).

That the acquired combination of the ECU-IDs is not stored in the server apparatus 1 means that the target battery pack 4 has been mounted on the target vehicle 3 for the first time (step S31: YES). In this case, the process transitions to step S23. If the acquired combination of the ECU-IDs is stored in the server apparatus 1, the process ends.

At step S23, the server apparatus 1 extracts a record corresponding to the target battery pack from the tracking information table stored in the storage 12 as in the second embodiment. Here, if the record is extracted (step S33: YES), the process ends. If the record is not extracted (step S33: NO), the process transitions to step S34, where the server apparatus 1 transmits data specifying restriction of functions to the target battery pack 4 (the ECU 41) via the vehicle 3 (the ECU 31). The ECU 41 that has received the data disables the target functions based on the list of functions stored in the storage 43 (step S25).

### (Modification)

The above embodiments are mere examples, and the present disclosure can be appropriately changed and implemented within a range not departing from its spirit.

For example, the processes and means described in the present disclosure can be freely combined and implemented as far as technical contradiction does not occur.

Furthermore, the processes described as being performed by one device may be shared and executed by a plurality of devices. Alternatively, the processes described as being performed by different devices may be performed by a single device. In a computer system, the hardware configuration (server configuration) by which each function is realized can be flexibly changed.

The present disclosure can also be realized by supplying a computer program implementing the functions described in the above embodiments to a computer, and having one or more processors of the computer read and execute the program. Such a computer program may be provided to the computer by a non-transitory computer-readable storage medium connectable to the system bus of the computer, or may be provided to the computer via a network. Non-transitory computer-readable storage media include, for example, any type of disk, such as a magnetic disk (e.g., a floppy disk, a hard disk drive (HDD), etc.), an optical disk (e.g., a CD-ROM, a DVD disk, a Blu-ray disk, etc.), a read-only memory (ROM), a random-access memory (RAM), an EPROM, an EEPROM, a magnetic card, a flash memory, an optical card, or any type of medium suitable for storing electronic instructions.

What is claimed is:

1. An information processing apparatus comprising a controller, the controller being configured to execute:
determining, for a battery apparatus mountable on a vehicle, whether predetermined information for tracking a location of the battery apparatus is registered with a predetermined management apparatus or not; and
disabling at least part of functions provided by the battery apparatus mounted on the vehicle when it is determined that the predetermined information is not registered.

2. The information processing apparatus according to claim 1, wherein, when detecting that the battery apparatus has been mounted on the vehicle, the controller makes the determination.

3. The information processing apparatus according to claim 1, wherein, when the predetermined information corresponding to the battery apparatus is registered with the predetermined management apparatus, the controller stores a combination of the vehicle mounted with the battery apparatus and the battery apparatus into a storage.

4. The information processing apparatus according to claim 3, wherein, when detecting that the battery apparatus has been mounted on the vehicle, the controller searches the storage for the combination of the vehicle mounted with the battery apparatus and the battery apparatus and does not make the determination if the combination is stored in the storage.

5. The information processing apparatus according to claim 1, wherein, when it is determined that the predetermined information is not registered, the controller issues an instruction to disable the at least part of the functions provided by the battery apparatus, to a battery control device that the battery apparatus comprises.

6. The information processing apparatus according to claim 1, wherein, when it is determined that the predetermined information is not registered, the controller disables second functions, among the functions provided by the battery apparatus, without disabling first functions.

7. The information processing apparatus according to claim 6, wherein
the first functions include functions required for a vehicle to travel and for safety, and
the second functions include a function of providing accompanying information.

8. An information processing system comprising:
a first apparatus configured to manage predetermined information for tracking a location of a battery apparatus mountable on a vehicle; and
a second apparatus communicable with a battery control device that the battery apparatus comprises, wherein
when the battery apparatus is removed from a first vehicle, the first apparatus accepts registration of the predetermined information about the battery apparatus, and
the second apparatus executes:
determining whether the predetermined information corresponding to the battery apparatus is registered with the first apparatus or not; and
disabling at least part of functions provided by the battery apparatus mounted on a second vehicle when it is determined that the predetermined information is not registered.

9. The information processing system according to claim 8, wherein, when detecting that the battery apparatus has been mounted on the second vehicle, the second apparatus makes the determination.

10. The information processing system according to claim 8, wherein, when the predetermined information corresponding to the battery apparatus is registered with the first apparatus, the second apparatus stores a combination of the second vehicle and the battery apparatus into a storage.

11. The information processing system according to claim 10, wherein, when detecting that the battery apparatus has been mounted on a vehicle, the second apparatus searches the storage for a combination of the vehicle mounted with the battery apparatus and the battery apparatus and does not make the determination if the combination is stored in the storage.

12. The information processing system according to claim 8, wherein, when it is determined that the predetermined information is not registered, the second apparatus issues an instruction to disable the at least part of the functions provided by the battery apparatus, to the battery control device.

13. The information processing system according to claim 8, wherein, when it is determined that the predetermined information is not registered, the second apparatus disables second functions, among the functions provided by the battery apparatus, without disabling first functions.

14. The information processing system according to claim 13, wherein
the first functions include functions required for a vehicle to travel and for safety, and
the second functions include a function of providing accompanying information.

15. The information processing system according to claim 8, wherein the first apparatus accepts registration of the predetermined information from a business operator terminal corresponding to a business operator who has removed the battery apparatus from the first vehicle.

16. The information processing system according to claim 15, wherein the predetermined information includes the business operator who has removed the battery apparatus from the first vehicle and information about a purpose of the removal of the battery apparatus.

17. An information processing method for an information processing apparatus to execute:
determining, for a battery apparatus mountable on a vehicle, whether predetermined information for tracking a location of the battery apparatus is registered with a predetermined management apparatus or not; and
disabling at least part of functions provided by the battery apparatus mounted on the vehicle when it is determined that the predetermined information is not registered.
